(19) United States
(12) Patent Application Publication
(10) Pub. No.: US 2013/0209714 A1
(43) Pub. Date: Aug. 15, 2013

(54) PAPER/FABRIC COMPOSITE USED IN THE MANUFACTURE OF BAGS, CASES AND COVERS

(71) Applicant: PAPERNOMAD GmbH, (US)

(72) Inventor: Christoph M. Rochna, Vienna (AT)

(73) Assignee: PAPERNOMAD GmbH, Vienna (AT)

(21) Appl. No.: 13/838,756

(22) Filed: Mar. 15, 2013

Related U.S. Application Data
(63) Continuation-in-part of application No. PCT/EP2011/073555, filed on Dec. 21, 2011.
(60) Provisional application No. 61/426,814, filed on Dec. 23, 2010.

(51) Int. Cl. B32B 1/02; B32B 5/00; B32B 29/02

(52) U.S. Cl. CPC B32B 1/02; B32B 29/02; B32B 5/00
USPC 428/35.2; 442/165; 428/219

(57) ABSTRACT

A paper/fabric composite behaving like a fabric sheet material with all the benefits of paper includes a Kraft paper and a viscose fabric laminated to the Kraft paper. The composite may be formed into a case including a first piece of the paper/fabric composite and a second piece of the paper/fabric composite. The first piece of the paper/fabric composite and the second piece of the paper/fabric composite being sewn together to form the case. Furthermore some functional components of the cases may be supplemented by a paper/biopolymer composite.

### CROSS REFERENCE TO RELATED APPLICATIONS

This application is a continuation-in-part of International Application Serial No. PCT/EP2011/073555, entitled “PAPER/FABRIC COMPOSITE USED IN THE MANUFACTURE OF BAGS, CASES AND COVERS/” filed Dec. 21, 2011, which is currently pending, which claims the benefit of U.S. Provisional Application 61/426,814, entitled “PAPER/FABRIC COMPOSITE USED IN THE MANUFACTURE OF BAGS, CASES AND COVERS,” filed Dec. 23, 2010.

### BACKGROUND OF THE INVENTION

1. Field of the Invention

The invention relates to bags, cases and covers made from a paper/fabric or a paper/biopolymer composite. More particularly, the invention relates to bags, cases and covers made from Kraft paper integrated with a viscose fabric or cellulose fibers incorporated into a fleece with a biopolymer that behave like fabric with all the benefits of traditional paper.

2. Description of the Related Art

Although most bags, cases and covers are made from leather, synthetic leather or fabric, they do not provide users with a preferred solution that incorporates environmental awareness and personal fashion. While traditional leather, synthetic leather and fabric bags and cases provide a durable place for the storage of goods, these materials exhibit three key problems.

One, they are made from environmentally negative materials. Leather is derived directly from animal hides. These animal hides are often sourced from developing nations. Synthetic leathers and fabrics are made from petroleum-derived sources. While these materials are not directly derived from animal hides, they do exhibit “green” issues, for example, land use and worker abuse. In addition, and regardless of whether leather, synthetic leather of fabric is employed, there are many examples from companies which have suffered backlash due to the sources of their leather, synthetic leather and/of fabrics.

Second, most cases and covers made from durable material such as plastic or leather in its various shapes and forms become trash after their relatively short period of being used.

They are commonly made to outlast the devices they are supposed to house. While electronic devices may be designed with a specific life expectancy in mind, the cases or covers that are made specifically for them last much longer. As new devices are released, the cases or covers that were designed for them become obsolete as the physical dimensions often change.

Third, although exceedingly durable, leather, synthetic leather and most fabrics do not provide a mechanism for individualized expression or personal fashion. For example, it is difficult, if not impossible, to write or draw on these materials. Leather, synthetic leather and most fabrics also tend to repel wear and the markings of wear so it takes an extended period of time for them to show signs of use. While some consider durability an advantage, others appreciate the aesthetic of well-worn products and the lack of wear in modern products may be thought of as a disadvantage to these people.

The signs of use or wear in a product are important because modern society is saturated with products that have no character or soul of their own. There are far too many “look-alike” products on the market. Most of these products emerge from faceless, mass production factories in faraway places. There is a growing intrinsic need in people to develop and record their own identity. It is the belief of the present inventor that the statement “you need to know where you come from, to know where you are going” very well describes the emotional need of our society.

Today, most people live and work at a fast pace. They live far removed from their roots, with little knowledge of their true origin. The trend noticed by companies such as Pottery Barn and Restoration Hardware is the appreciation of old furniture, kitchen equipment, clothing and other items. These companies produce products that although new, present an appearance of wear and prior use. The perceived quality of such seemingly used or inherited things is that they have a past; a story to tell. In contrast, mass manufactured products exhibit no individuality for they all look the same. They all are replaceable and cheap, regardless of their price. They do not reflect the users' individuality and identity.

As such, the present inventor has developed the present paper/fabric composite providing durability in conjunction with the sustainable environmentally friendly and natural properties of paper.

A further development subject to this invention is a paper/biopolymer composite which provides ductility coupled with continuous tear resistance and homogeneity of the visual appearance. In conjunction with the sustainable, environmentally friendly and natural properties of paper and the bio-degradable properties of bio-polymers. This material provides a functional supplement to the paper/fabric composite in situations where there is additional motion or where a hinging functionality is desired.

The present inventor has further developed an application whereby paper may be constructed into products that allow, and even encourage, personal expression in a world of seven billion people.

### SUMMARY OF THE INVENTION

It is, therefore, an object of the present invention to provide a paper/fabric composite behaving like a fabric sheet material with all the benefits of paper. The paper/fabric composite includes a Kraft paper and a viscose fabric laminated to the Kraft paper.

It is also an object of the present invention to provide a paper/fabric composite wherein the viscose fabric is a viscose fleece.

It is another object of the present invention to provide a paper/fabric composite wherein the viscose fabric consists of viscose fibers.

It is a further object of the present invention to provide a paper/fabric composite wherein the viscose fibers are interwoven or amalgamated via hydro-entanglement.

It is also an object of the present invention to provide a paper/fabric composite wherein the viscose fabric has a specific weight of 40-130 g/m².

It is another object of the present invention to provide a paper/fabric composite wherein the Kraft paper has a specific weight of approximately 50-300 g/m².

It is a further object of the present invention to provide a paper/fabric composite wherein a biopolymer or starch-based adhesive film is positioned and secured between the Kraft paper and the viscose fabric to act as a bonding agent.

It is also an object of the present invention to provide a paper/fabric composite wherein biopolymer adhesive film has a specific weight of 5-80 g/m².

It is another object of the present invention to provide a paper/biopolymer composite wherein biopolymer impregnated cellulose fiber fleece has a specific weight of 127-945 g/m².

It is another object of the present invention to provide a case comprising a first piece of a paper/fabric composite behaving like a fabric sheet material with all the benefits of paper. The paper/fabric composite includes a Kraft paper and a viscose fabric laminated to the Kraft paper. The case also includes a second piece of the paper/fabric composite. The first piece of the paper/fabric composite and the second piece of the paper/fabric composite are sewn together to form the case.

It is a further object of the present invention to provide a case wherein the Kraft paper of the first piece of the paper/fabric composite and the second piece of the paper/fabric composite face outwardly and define an exterior surface of the case, and the viscose fabric of the first piece of the paper/fabric composite and second piece of the paper/fabric composite face the interior of the case and define the interior surface of the case.

It is also an object of the present invention to provide a case wherein a liner is positioned adjacent each of the first piece of the paper/fabric composite and the second piece of the paper/fabric composite along the interior surface of the case.

It is another object of the present invention to provide a case wherein the viscose fabric is a non-woven viscose fleece.

It is a further object of the present invention to provide a case wherein the viscose fabric consists of viscose fibers.

It is also an object of the present invention to provide a case wherein the viscose-fibers are amalgamated via hydro-entanglement.

It is another object of the present invention to provide a case wherein the viscose fabric has a specific weight of 40-130 g/m².

It is a further object of the present invention to provide a case wherein the Kraft paper has a specific weight of approximately 50-300 g/m².

It is also an object of the present invention to provide a case wherein a biopolymer or starch-based adhesive film or wallpaper glue is positioned and secured between the Kraft paper and the viscose fabric.

It is another object of the present invention to provide a case wherein biopolymer or starch-based adhesive film has a specific weight of 5-80 g/m².

It is another object of the present invention to provide a case wherein the paper/biopolymer composite has a specific weight of 127-945 g/m².

It is a further object of the present invention to provide a case wherein the Kraft paper of the first piece of the paper/fabric composite and the second piece of the paper/fabric composite is treated with wallpaper glue.

It is also an object of the present invention to provide a case including a strap secured to the first piece of the paper/fabric composite.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a cut away view of a sheet of the paper/fabric composite in accordance with the present invention.

FIG. 2 shows the various layers making up the paper/fabric composite.

FIG. 3 is a perspective view of a case made using the paper/fabric composite.

FIG. 4 is a partial cross sectional view of the case shown in FIG. 3.

FIG. 5 is a cross sectional view of the case along the line 5-5 in FIG. 4.

FIG. 5A is a detailed view of the section 5A shown in FIG. 5

FIGS. 6 and 7 show other views of the case shown in FIGS. 3, 4, 5 and 5A.

FIGS. 8-14 show various products that may be manufactured with the present paper/fabric composite.

FIG. 15 is a schematic showing extrusion of the biopolymer or starch-based adhesive and the compression of the paper/fabric composite.

FIG. 16 is a schematic showing the layering of an alternate paper/fabric composite.

FIGS. 17-22 show various assembly steps in accordance with the present invention.

FIG. 23 is a partial cut away view showing a view of the paper/biopolymer composite providing for a hinging mechanism.

FIG. 24 shows a detailed view of the paper/biopolymer composite functioning as part of a case or cover where the edges can be left exposed.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

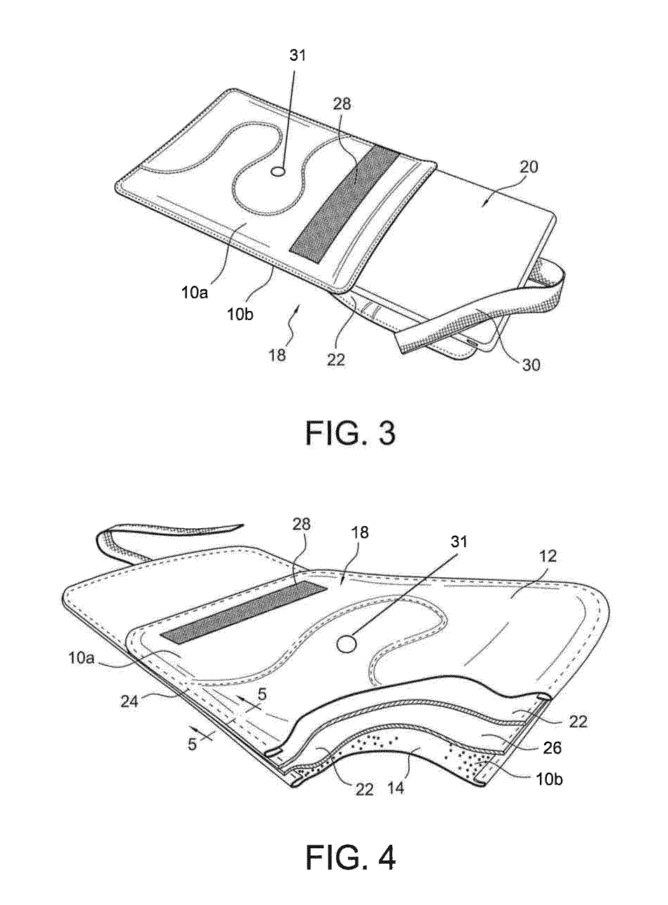

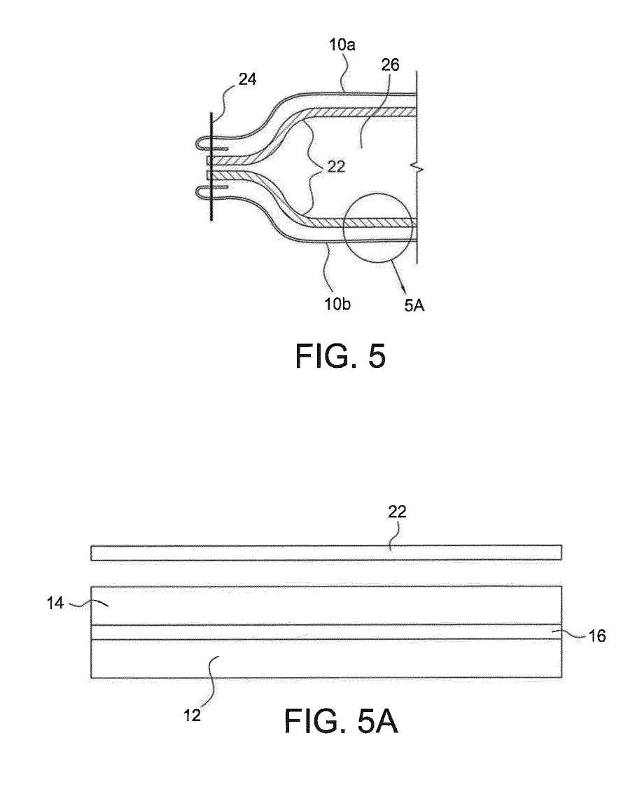

In accordance with the present invention, and with reference to the various figures disclosed herein, bags, cases and covers made from a paper/fabric composite 10 are disclosed. In accordance with a preferred embodiment of the present invention, a sheet, including a continuous sheet or roll, of Kraft paper 12 is combined with a sheet of viscose fabric 14 to create a new paper/fabric composite 10 that behaves like fabric sheet or roll material with all the benefits of paper. This paper/fabric composite 10 is used in the manufacture of bags, cases and covers, more particularly, but not limited to, wallets, hand bags, laptop and/or desktop computer cases, electronic device cases, book covers, bean bags and other fashion, home and office products as shown with reference to FIGS. 3 to 14.

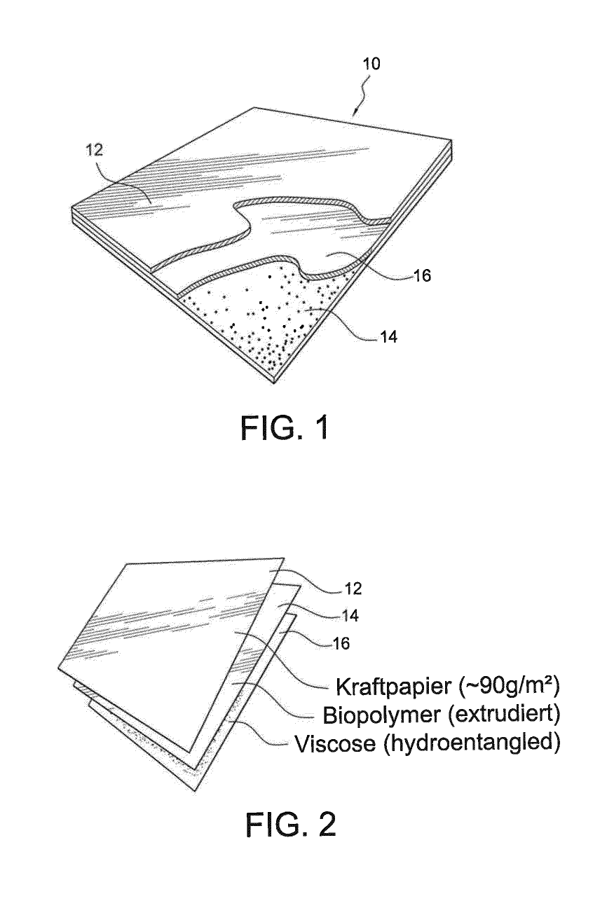

Referring to FIGS. 1 and 2, and in accordance with a preferred embodiment, brown, white or colored Kraft paper 12 is employed. The Kraft paper 12 has a specific weight of approximately 50-300 g/m². More particularly, the Kraft paper employed in accordance with a preferred embodiment of the present invention has a specific weight of preferably 90 g/m².

As is appreciated, these Kraft papers have long fibers and other components parts from which they are manufactured. These fibers, and their combination in the Kraft paper, provide exceptional tensile strength, notch-impact-resistance, flexibility and stretchability.

The Kraft paper 12 is combined with a viscose fabric 14, in accordance with a preferred embodiment, a viscose fleece (that is, a fabric with a soft deep pile). The lamination of viscose fabric 14 with the Kraft paper 12 increases tensile strength and notch-impact-resistance necessary to achieve tear resistance for the manufacture of bags, cases and covers as described herein. As will be appreciated, viscose fabric generally refers to fabrics made of a viscous organic liquid (e.g. Polylactic acid or polylactide) commonly used in the manufacture of rayon and cellophane.

In accordance with a preferred embodiment, the viscose fabric 14 is composed of nothing but viscose fibers. Although sometimes defined as any woven material, in this invention fabric is considered include woven and non-woven materials. These fibers are not glued together, as in the case of normal paper, but combined, amalgamated or interwoven employing the methodology of hydro-entanglement or other suitable methods known to those in the art. As is appreciated, hydro-entanglement involves the formation of fabrics by piercing a thick and loose layer of fibers with high pressure, water jets which entangle fibers with one another. This process results in a high strength non-woven viscose fabric with enhanced environmental qualities. Because the viscose fabric may not be woven, it is better suited for sewing. In particular, when sewing a woven fabric, some—if not many—of the strands of the fabric are being cut, thus creating a starting point for fracture of the remaining fabric. The non-woven strands overcome this problem, because they do not rely on one integral system of coherent strands. In accordance with a preferred embodiment, the viscose fabric 14 employed in accordance with the present invention has a specific weight, of 40-130 g/m².

The Kraft paper 12 and viscose fabric 14 are married, that is, integrated into an integral structure, by a biopolymer adhesive film 16 positioned and secured therebetween. In accordance with a preferred embodiment, the biopolymer adhesive film 16 is produced by extrusion lamination. The biopolymer adhesive film 16 is extruded between the Kraft paper 12 and the viscose fabric 14 (see FIG. 15 as discussed below). In accordance with a preferred embodiment, the biopolymer adhesive film 16 has a specific weight of 5-80 g/m² and is a biodegradable structure based on cellulose derived from biomass. The biopolymer adhesive film 16 supports the bio-degradability of the end product, that is, the paper/fabric composite sheet 10. The biopolymer adhesive film 16. The material breaks down when exposed to moisture and elevated temperatures that naturally occur during the decomposition process where it is being disintegrated by micro-bacteria or other environmental factors. Typically this breakdown process happens in special recycling facilities but may also take place in domestic composting facilities. As such, products manufactured with the present paper/fabric composite 10 may also be disposed of within the paper-recycling process where the paper and the viscose fabric can be recycled. The biopolymer, however, is not recycled separately but will be tolerated by recyclers because it accounts for a relatively small proportion of the total composite.

In practice, and referring to FIG. 15, the biopolymer adhesive film 16 is extruded in the form of a thin liquefied film and positioned between the Kraft paper 12 and the viscose fabric 14. The assembled layers are then passed over one or a multitude of rollers 40 under tensile force in a manner creating pressure causing the layers to bond based upon the coupling characteristics of the cooling-down biopolymer adhesive film 16. Ultimately, the combined laminated structure of the Kraft paper 12, viscose fabric 14 and biopolymer adhesive film 16 has a specific weight of approximately 200 g/m²+/−40%. The biopolymer adhesive film 16 acts as a glue to bond the Kraft paper 12 and the viscose fabric 14 together, thus creating a very strong, yet light and biodegradable sandwich. This process also naturally endows the paper/fabric composite 10 with a moisture barrier, helping to prevent the penetration of liquids in the consumer applications discussed above.

It is appreciated that the paper/fabric composite 10 can also be treated in various ways to achieve desired characteristics. For example, it may be treated with fire retardant materials to comply with potential requirements and end user needs. This could be achieved in a biodegradable way via a liquid based on citric acid or other environmentally friendly treatments. The biodegradable fire retardant material may be introduced in the making of the paper or sprayed on the paper/fabric composite at a later production stage. It is contemplated later spraying would occur at the very last operation prior to dispatch.

It is further contemplated that other treatments may be employed. For example, the paper/fabric composite may be vacuum formed or embossed to create a pattern or logo upon the material. The Kraft paper may also be pretreated, that is prior to integration with the fabric, with other ingredients to achieve better water resistance, or suitability for food handling. The paper/fabric composite of the present invention provides for tear resistance, water resistance, flexibility, biodegradability, flame retardant and environmentally conscious manufacture considering that all components are food-grade. Water resistance is achieved through the utilization of the biopolymer in the extrusion lamination of the Kraft paper with the viscose fabric. As is appreciated, the Kraft paper itself is not water resistant, but will still exhibit exceptional tear resistance when soaking wet based upon the long cellulose fibers from which the Kraft paper is primarily composed.

With regard to flexibility, the paper/fabric composite may be preferably stretched by 10-20%. As such, the paper/fabric composite may be vacuum formed in a manner exhibiting a compound surface, that is, a surface exhibiting a three dimensional characteristic. The embossing/vacuum forming allows one to increase the haptic quality of the material. Through such embossing a 3-dimensional logo may be applied lending the product a stronger presence. The deformability of the paper/fabric composite may also be utilized to create compound elements which are designed to enclose the compound shape of electronic devices.

The proposed combination of the paper/fabric composite also provides a suitable material for being sewn. Traditional papers do not sew well due to the fact that the holes punched into the paper by the needle(s) tend to weaken the surrounding material. It is analogous to a perforation process which is not desirable. This proposed invention overcomes this natural tendency via the reinforcement offered by the viscose fabric and biopolymer sandwich.

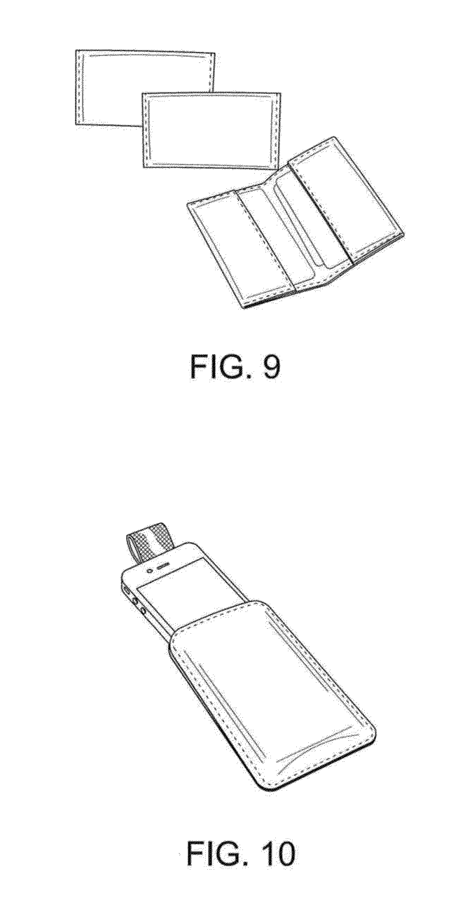

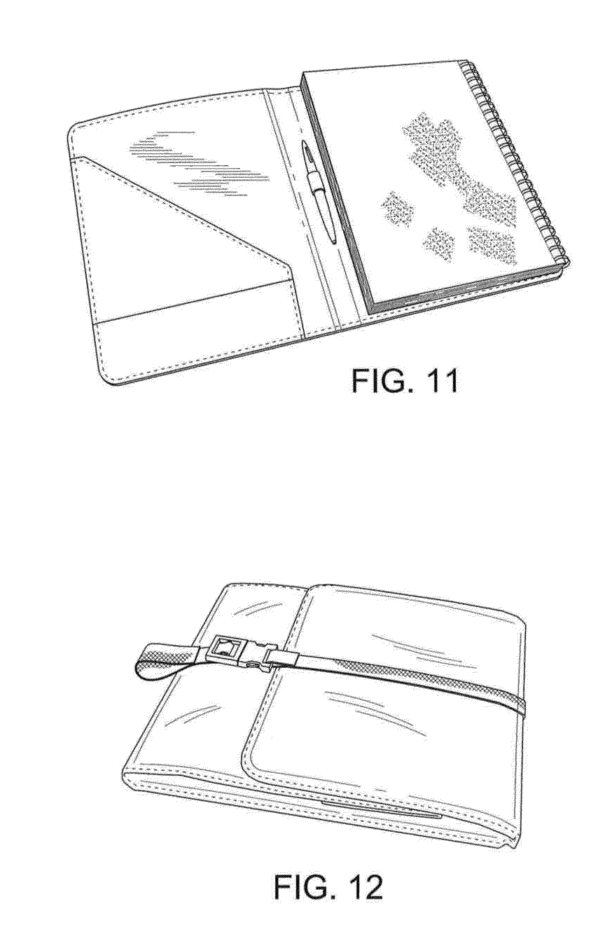

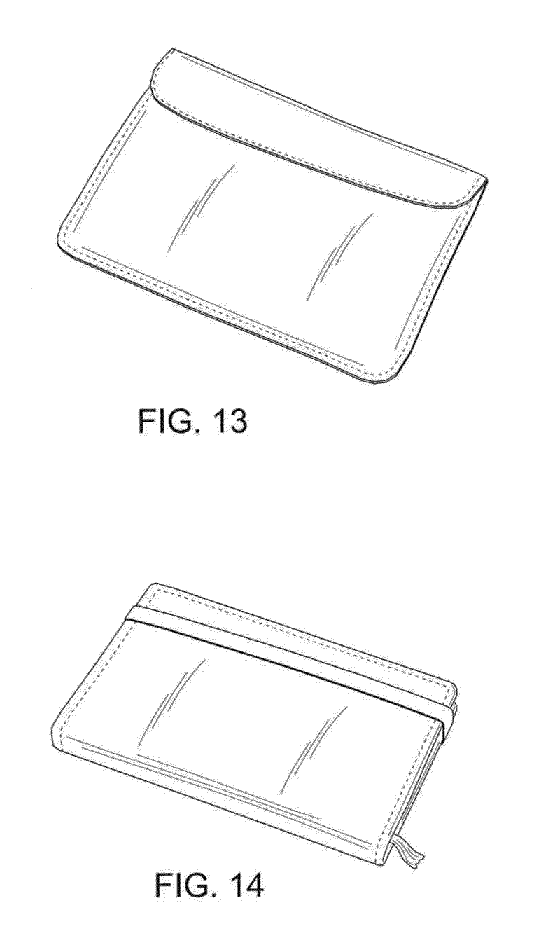

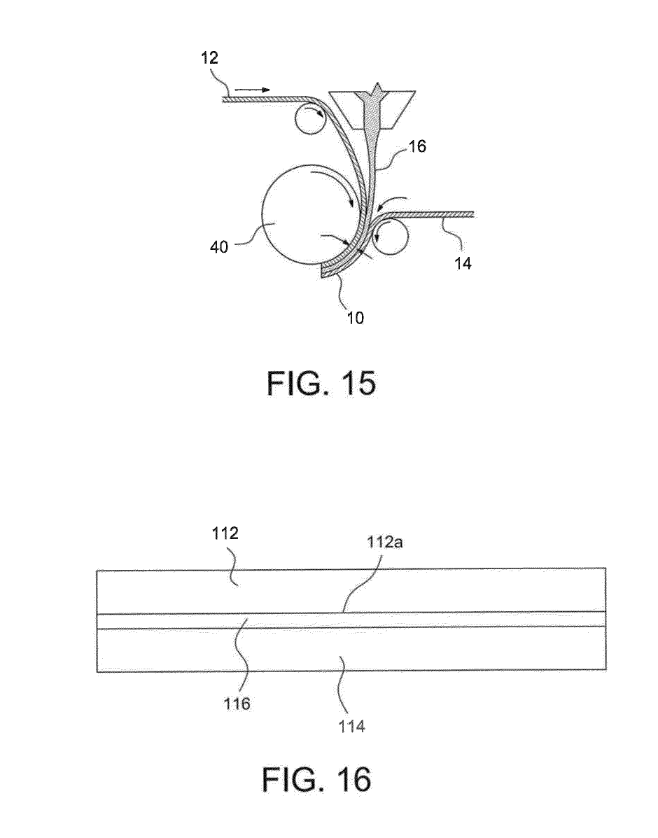

Once the paper/fabric composite is formed, it may be readily fabricated into various bags, cases and covers. As shown with reference to FIGS. 3, 4 and 5, one possible product which may be manufactured from the present paper/fabric composite 10, is a case 18 for a portable computer device 20, for example, an iPad. In addition, to the case discussed above, the potential consumer products include, but are not limited to: wallets (see FIG. 9) for credit cards, cash and/or coins and travel wallets (for passport, ticket, boarding pass, frequent flyer cards, etc); handbags and purses; pencil cases, writing/desktop utensils, paper bins; cases/skins for laptops, iBook, iPhone (see FIG. 10), iPod, Blackberry, Palm Pilot, mobile phones and cameras; covers for sketchbooks, notebooks and portfolios (see FIGS. 11 and 12); dashboard covers (to reflect harsh sun light and write notes/memories thereupon); clothing, home decoration, tablecloth, furniture (hang-mat, bean bag), messenger bags, conference folders (see FIG. 13), filofax, bookcovers (see FIG. 14), picnic baskets, backpacks, water bottles with bio-polymer bladder, hip-flask envelope, suitcase name tag, tool bag, deck-chair (that is, wooden frame with inventive paper/fabric composite in place of the usually used fabric), cooking gloves, flexible office water bottles/coolers, key ring fobs (see FIG. 8), pet cushion, toys and packaging applications.

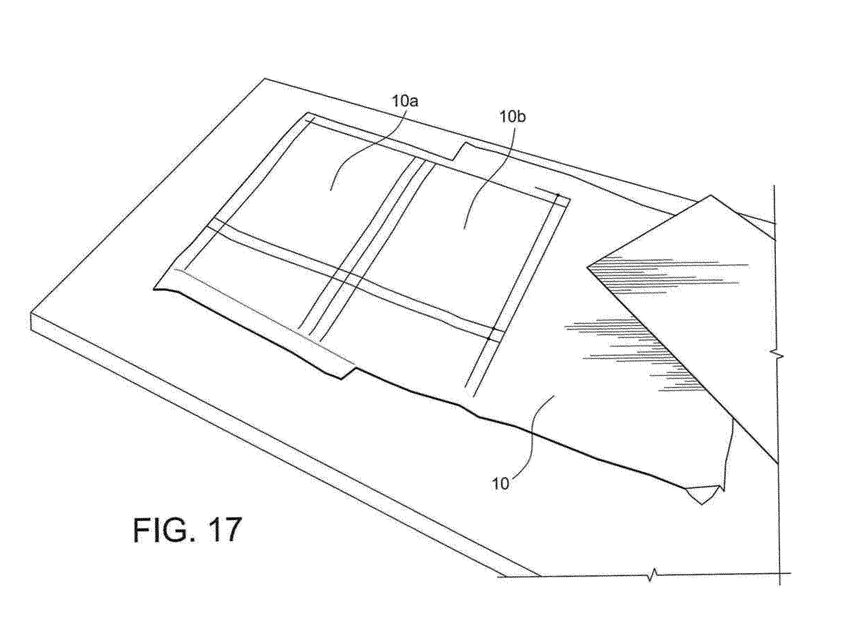

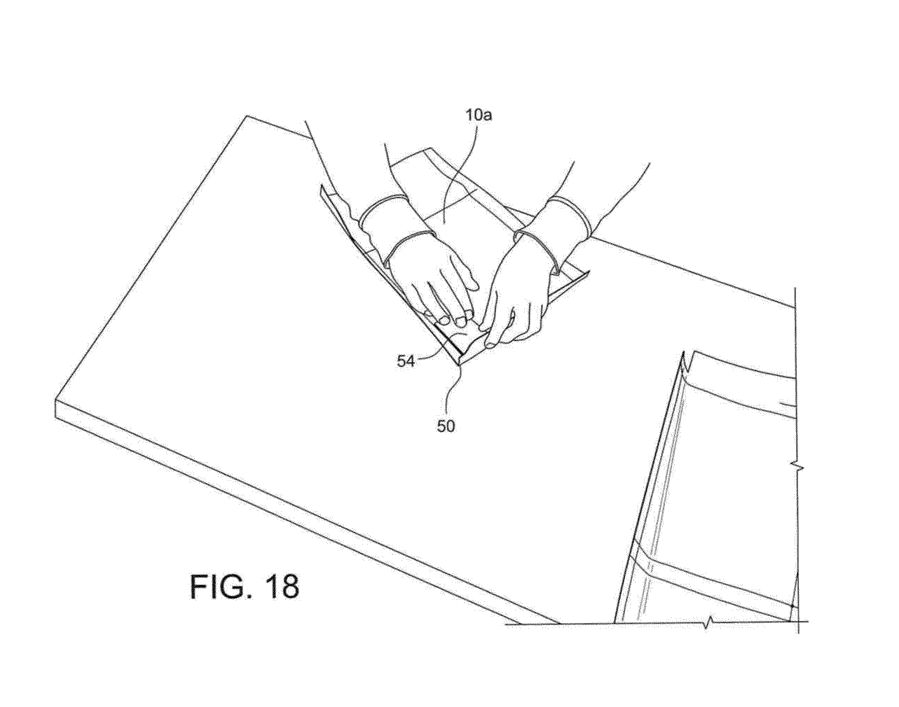

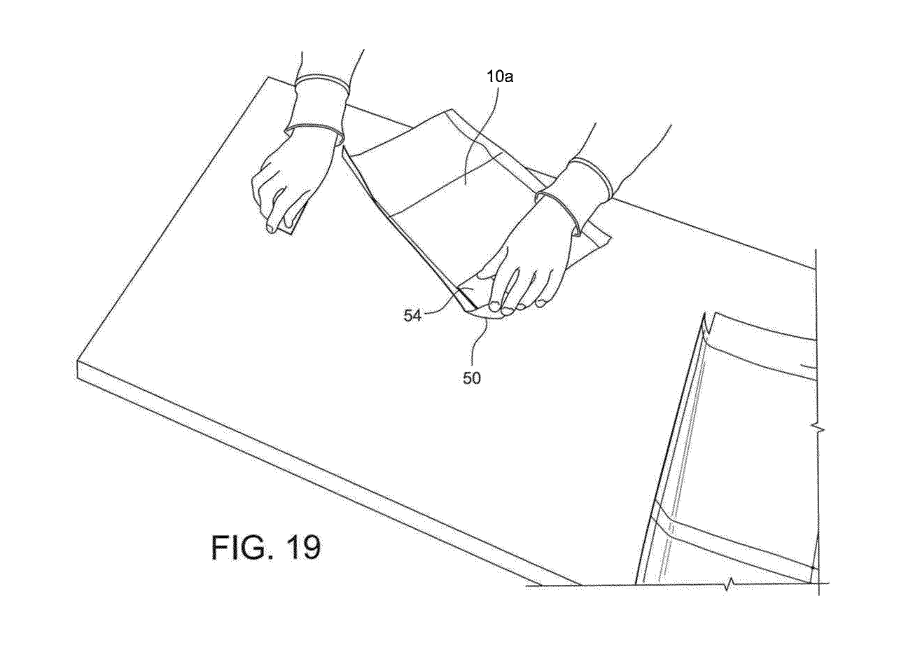

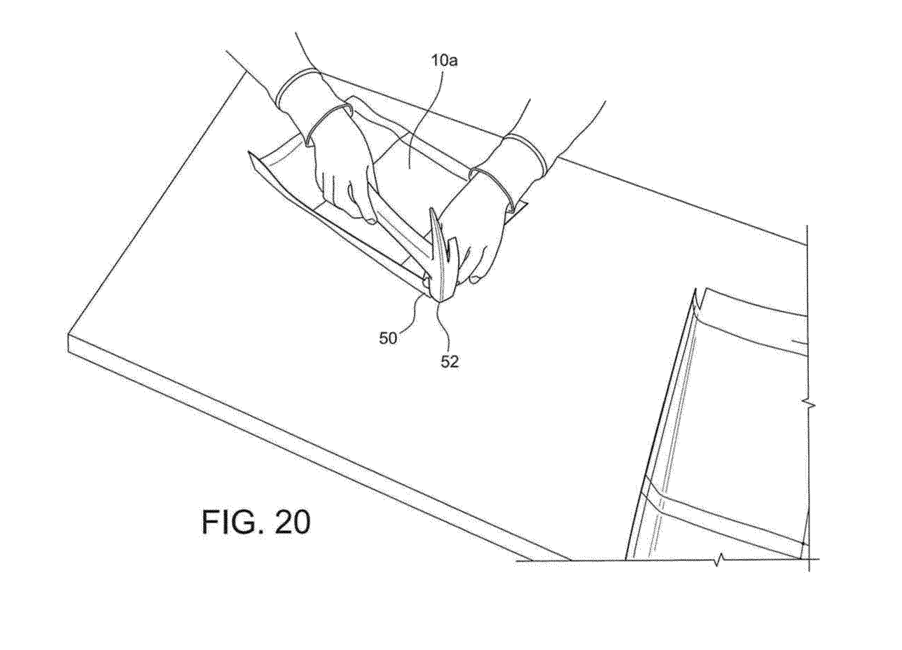

With the exception of the external formation and sewing of radiused edges, it is contemplated the method of manufacturing the bags, cases and covers from the present paper/fabric composite 10 is not unlike the manufacture of conventional bags made from leather, synthetic leather or fabric. In accordance with a preferred embodiment, various pieces 10a, 10b of paper/fabric composite 10 are cut (see FIG. 17). However, and prior to sewing, the radiused edges of the pieces may be formed.

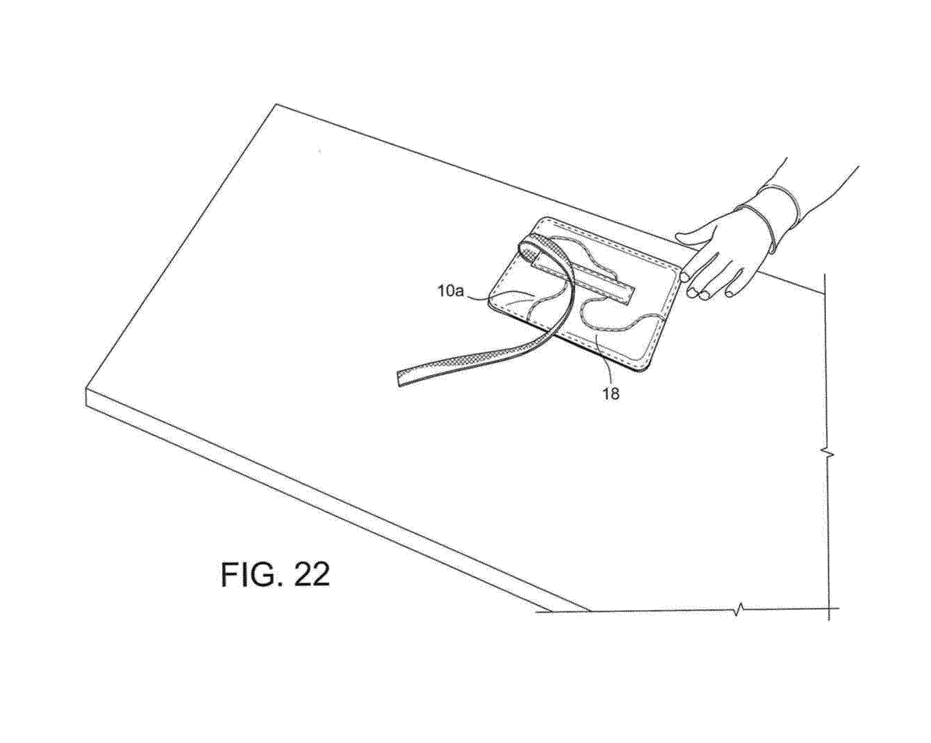

In contrast to traditional sewing of a radius edge with normal fabric, where the opposed sheets are sewn inside out (that is, the sides of the pieces of fabric that will face the outside (be exposed) in the finished product would be facing each other, the seam is sewn with the desired radii, and the combined/sewn piece is then turned inside out with various pieces together), a different technique is required in accordance with the present invention as such a procedure does not work with the present paper/fabric composite 10. In accordance with the present invention, and with reference to FIGS. 18, 19 and 20, the radiused edges 50 of the pieces 10a (only one radiused edge of one of the pieces is shown although it is appreciated all radiused edges are formed in the same manner) are formed prior to sewing by folding down the edge 50 and applying a weighted object such as a hammer or iron 52 to make the fold permanent. In accordance with the embodiment disclosed herein, the radiused edge of a credit card 54 is used as a template in forming the radiused edges 50. Once the pieces are cut and the radiused edges are formed the various pieces 10a, 10b are assembled and sewn together with the Kraft paper 12 layer facing the exterior as disclosed with reference to FIGS. 21 and 22. The Kraft paper exterior of the case may also be sewn with various patterns. These patterns provide additional strength and also give the product interesting design elements and the opportunity for customization.

Each bag or product is made from pre-cut pieces of the paper/fabric composite 10 and the pre-cut pieces are sewn together. It is anticipated that a soft core and inner skin may be employed to protect electronic equipment and other valuables.

For example, and with reference to the case disclosed in FIGS. 3-7, the outer surface of the case 18 is composed of first and second pieces 10a, 10b of the paper/fabric composite 10, with the Kraft paper (that is the Kraft paper layer of the paper/fabric composite) 12 facing outwardly and the viscose fabric 14 facing the interior of the case 18. A liner 22, for example, cotton, hemp, linen, etc. is positioned adjacent each of the first and second pieces 10a, 10b of the paper/fabric composite 10 along the interior surface of the case 18, that is, in a facing relationship with the viscose fabric 14. The liners 22 face each other and provide a protective surface for the iPad 20 slip therein. Once the various layers are arranged, the case is sewn together with thread 24 creating a pocket 26 in which a user may selectively place his or her device.

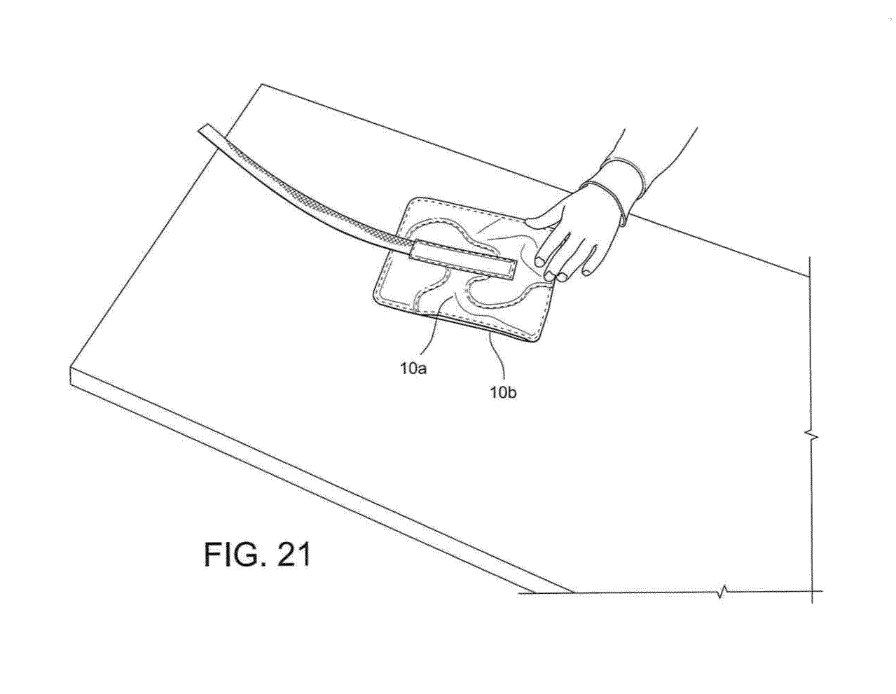

In an alternate embodiment, the paper/fabric composite described above may be supplemented or replaced by a paper/biopolymer composite. In accordance with this alternate embodiment, the paper/biopolymer composite is effectively a single layer but exhibits additional benefits due to its unique construction. It particular, the paper/biopolymer composite is a combination of cellulose fibers—formed into a fleece—combined with a binder such as a biopolymer. This combination produces a paper-like composite with features not altogether different than sheets or rolls of polymer material; that is, you can alter the ratio of the paper (cellulose fibers) to biopolymer to control the characteristics of the composite such that a higher ration of paper will result in more paper like characteristics and a higher ration of biopolymer will result in more polymer characteristics. The thickness is greater than the paper/fabric composite described above with an approximate specific weight of 127-945 g/m². The primary benefit of the paper/biopolymer composite is its ductility. In an area of a case where there is a great deal of motion or bending, the paper/biopolymer composite maintains its dimensions and shows less wear. In addition, it can be used without bending or rounding the edges due the greater resistance to wear offered by the paper/biopolymer composite. This allows for alternative designs where rounded edges (that is, the edge structure disclosed above with reference to FIGS. 18 and 19) are not desired. Regardless of the difference between the paper/fabric composite and the paper/biopolymer composite, the paper/biopolymer composite may be utilized in the manufacture of bags, cases and covers in the same manner in which the paper/fabric composite is employed as described herein. In addition, it is appreciated the paper/fabric composite and paper/biopolymer composite may be utilized in combination, for example, paper/biopolymer composite edge and paper/fabric composite body, where deemed appropriate.

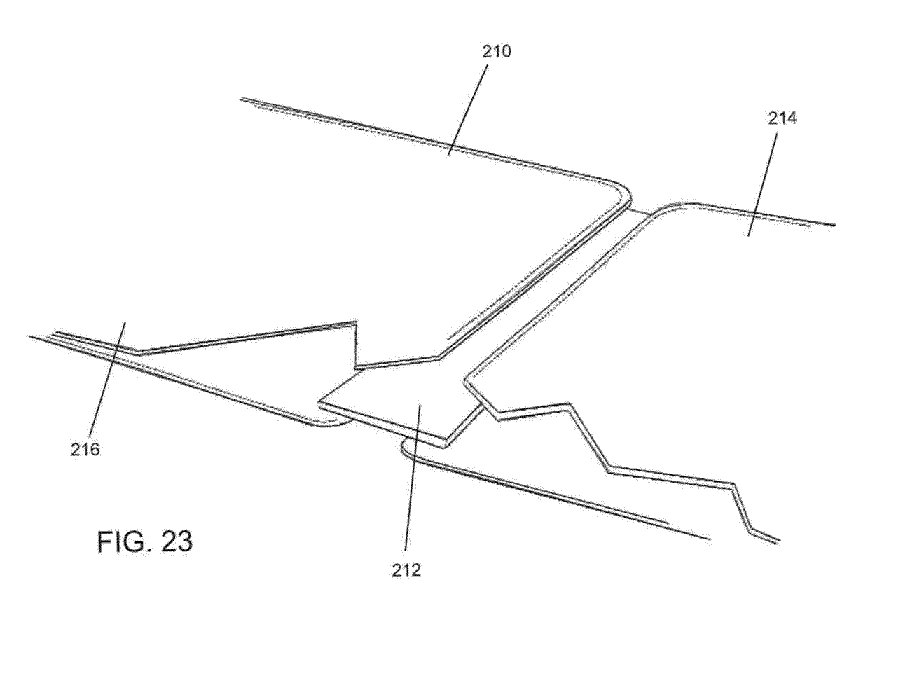

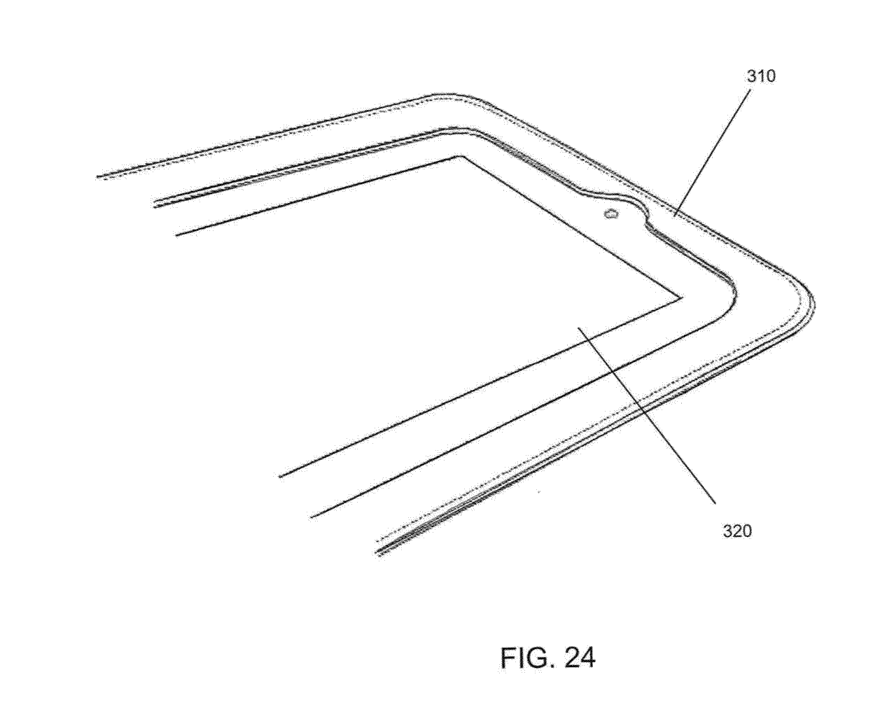

Considering the material characteristics of the paper/biopolymer composite, it finds particular application in the construction of hinges found in bags cases and covers, as well as in the construction of edges in cases or covers where the edge can be left exposed. In particular, and with reference to FIG. 23, a case 210 is disclosed which includes a hinge 212 connecting a backing member 214 and the cover member 216. In accordance with such a case 210, the hinge 212 is composed of the paper/biopolymer composite described above, while the backing member 214 and cover member 216 are composed of either the paper/biopolymer composite or the paper/fabric composite. It is appreciate, the backing member 214 may be provide with structure (for example, adhesive, clips, fasteners, or other mechanism) for attaching a smart phone, tablet or other personal electronic device thereto in a manner known to those skilled in the art, while the cover member 216 is shaped and dimensioned such that it can by pivotally moved relative to the backing member 214 using the hinge 212 to control the movement of thereof. As described above, the various components making up the present case may be sewn together. Referring now to FIG. 24 a case 310 made of the paper/biopolymer composite is disclosed. As a discussed above, the smart phone, tablet or other personal electronic device 320 is placed within the case 310 for protection thereof. Because of inherent elasticity in the paper/biopolymer composite the smart phone, tablet or other personal electronic device 320 may be fit within the case 310 by stretching the case 310, inserting the smart phone, tablet or other personal electronic device 320

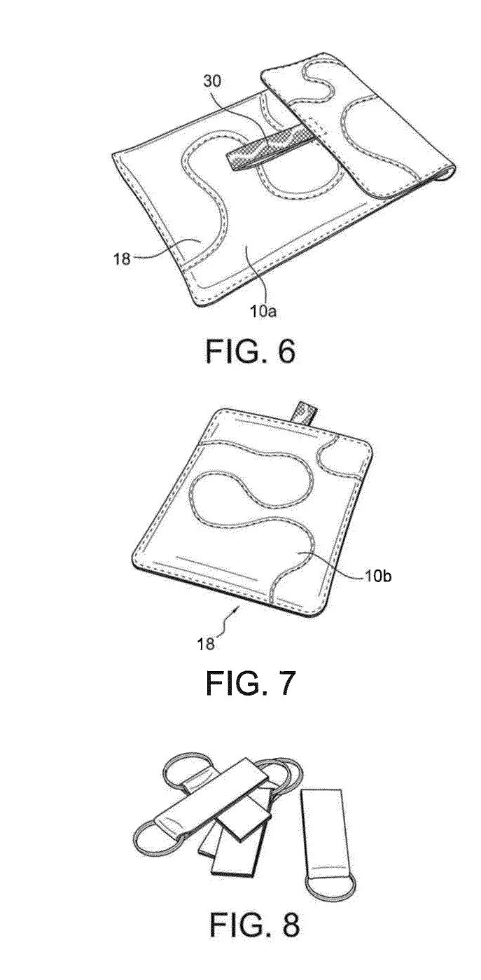

In accordance with a preferred embodiment of the present invention, the cores or inner skins employed in accordance, with the present invention are manufactured from natural materials, for example, wool, cotton, hemp, linen etc. In addition, carry straps, buttons, buckles or magnets (see hook and loop fastener 28 and strap 30 as seen in FIGS. 3 and 6) may be employed to secure the contents and hold shut the bags, cases and cover manufactured in accordance with the present invention. In accordance with a preferred embodiment, the fastener 28 and the strap 30 are secured to the first piece 10a of the paper/fabric composite. The strap 30 is preferably incorporated into the interior of the case 18 with the free end of the strap 30 releasably attachable to the case 18 (for example, via attachment to a buckle (not shown), button 31 or magnet (not shown) to secure the contents therein. It is, appreciated the strap may be composed of various materials.

It is further contemplated that areas that require more structural strength may be reinforced with thin cardboard or other materials incorporated between layers of the paper/fabric or paper/biopolymer composite.

It is also anticipated that the bags will feature large, flat surfaces where possible and that the paper/fabric or paper/biopolymer composite will be utilized to create ample space for scribble, taking notes and/or marking the surface thereof. The seams will be composed of strong, thick and environmentally friendly thread to emphasize the genuine nature of the product and ensure secure joints. Wherever possible the use of synthetic adhesives and/or polymers is avoided.

One desirable aesthetic characteristic of the paper/fabric or paper/biopolymer composite is the formation of creases when merging the paper with the viscose fabric using certain adhesives such as wallpaper glue in accordance with an alternate embodiment. Certain adhesives or other treatments cause the paper to warp due to the high moisture content. When the paper and fabric are brought together using wallpaper glue, an ordinary iron may be used to dry and bond the two components. This ironing allows for the deliberate formation of creases and wrinkles in the paper. The wrinkles blend into the material creating a leather-like pattern. As with leather, the pattern cannot be recreated, thus creating a one-of-a-kind and aesthetically pleasing surface on every bag. Furthermore, the design of the paper/fabric or paper/biopolymer composite bags, cases and covers highlights the materials and construction methods used thereby, differentiating the product manufactured in accordance with the present invention from those currently on the market.

In particular, and in accordance with this alternate embodiment as shown with reference to FIG. 16, the Kraft paper 112 is laid out flat onto an even surface. Wallpaper glue 116, at low concentration, is brushed onto a first side 112a of the Kraft paper 112 (for example, by hand). The wallpaper glue 116 will soak into the Kraft paper 112. As a result of the manual application of the wallpaper glue 116, the distribution of the glue is uneven and so are the resulting warps and buckles. The viscose fabric 114, in particular, viscose fleece, is then placed on top of the Kraft paper 112 along the first side 112a of the Kraft paper 116 to which the wallpaper glue 116 was previously applied. The viscose fabric 114 is then pressed onto the Kraft paper 112. While the assembled Kraft paper/wallpaper glue/viscose fabric assembly is still moist, it is turned upside down so that the Kraft paper 112 is facing up. In this orientation the Kraft paper/wallpaper glue/viscose fabric assembly is ironed using a normal clothes iron. The Kraft paper/wallpaper glue/viscose fabric assembly is then consolidated into an integral sheet composed of the paper/fabric composite 110 as shown in FIG. 16. Wherever the warps occurred, they can be deformed into wrinkles to give the paper/fabric composite 10 a very individual appearance: no two papers will be identical when this process is used. The wrinkles blend into the paper/fabric composite 10 creating a leather-like pattern. As with leather, the pattern cannot be recreated, thus creating a one-of-a-kind and aesthetically pleasing surface on every bag. Furthermore, the design of the paper/fabric or paper/biopolymer composite bags, cases and covers highlights the materials and construction methods used thereby, differentiating the product manufactured in accordance with the present invention from those currently on the market.

In addition to soft bags, cases and covers, the paper/fabric or paper/biopolymer composite may be formed into harder or hard-shell cases or forms. Through the use of extrusion, vacuum forming, embossing, and other manufacturing methods commonly know in the art.

The benefits of making bags, cases and covers are manifold. One, the paper/fabric or paper/biopolymer composite material used in the construction of the identified products is environmentally friendly. Paper is a renewable resource and one that is commonly recycled. Paper is made from planted trees, which have a positive net effect on the atmospheres and reduce the effects of pollution in urban environments. Two, with accelerating innovation-cycles in the electronics industry, the life span of electronic devices becomes increasingly shorter, which in turn eliminates the need for cases of covers to be as durable as synthetic materials render them to be. New devices come in new shapes and forms and require ever-new cases or covers, which results in large volumes of old cases or covers winding up as domestic refuse. Cases or covers made from bio-degradable material can be composted and thus dynamically adapt to the speed of innovation cycles of electronic devices. Three, another significant justification for paper products is the emerging need of personal identify in the world. When the disclosed bags, cases and covers made of the paper/fabric or paper/biopolymer composite in accordance with the present invention leave the factory, they will appear relatively similar. However, as soon as a user takes possession of his or her bag with a touch, it begins to carry individual marks. In particular, the paper/fabric or paper/biopolymer composite allows it to act as a record of the person's travels, experiences and encounters. The disclosed paper/fabric or paper/biopolymer composite bags, cases and covers provide an instant notepad or ready canvas that the user carries with him or her. A complex and beautiful story is recorded in the form of telephone numbers jotted down, coffee spills, lipstick marks, crazy doodles and countless other notations of life. After some years, it provides the user with cues and clues to stories that could have filled an entire book and document the days gone by.

Although the paper/fabric or paper/biopolymer composite of the present invention is not expected to last as long as most leather, synthetic leather or common fabric used for current bag manufacturing, it is anticipated the bags, cases and covers manufactured from paper/fabric or paper/biopolymer composites in accordance with the present invention will have a life expectancy of many months, even when used every day.

Ultimately, the present invention provides a solution to the current problem of environmentally unfriendly materials used for the construction of boring and mass produced bags, cases and covers with an appropriate life-span. Furthermore, this invention utilized unique paper/fabric or paper/biopolymer composite materials that allow for a functional bag or case with an interesting character. This paper/fabric or paper/biopolymer composite also allows the individual and world to leave its marks, therefore, making the bag or case a real expression of personality and real life experiences.

While the preferred embodiments have been shown and described, it will be understood that there is no intent to limit the invention by such disclosure, but rather, is intended to cover all modifications and alternate constructions falling within the spirit and scope of the invention.

1. A paper/fabric composite behaving like a fabric sheet material with all the benefits of paper, comprising:
a Kraft paper; and
a viscous fabric laminated to the Kraft paper.

2. The paper/fabric composite according to claim 1, where the viscous fabric is a viscose fleece.

3. The paper/fabric composite according to claim 1, wherein the viscous fabric consists of viscous fibers.

4. The paper/fabric composite according to claim 3, wherein the viscous fibers are interwoven or amalgamated via hydro-entanglement.

5. The paper/fabric composite according to claim 1, wherein the viscous fabric has a specific weight of 40-130 g/m².

6. The paper/fabric composite according to claim 1, wherein the Kraft paper has a specific weight of approximately 50-300 g/m².

7. The paper/fabric composite according to claim 1, wherein a biopolymer adhesive film is positioned and secured between the Kraft paper and the viscous fabric.

8. The paper/fabric composite according to claim 1, wherein biopolymer adhesive film has a specific weight of 5-80 g/m².

9. A case, comprising:
a first piece of a paper/fabric composite behaving like a fabric sheet material with all the benefits of paper, the paper/fabric composite includes a Kraft paper and a viscose fabric laminated to the Kraft paper; and
a second piece of the paper/fabric composite;
the first piece of the paper/fabric composite and the second piece of the paper/fabric composite being sewn together to form a case.

10. The case according to claim 9, wherein the Kraft paper layer of the first piece of the paper/fabric composite and the second piece of the paper/fabric composite face outwardly and define an exterior surface of the case, and the viscose fabric layer of the first piece of the paper/fabric composite and the second piece of the paper/fabric composite face the interior of the case and define the interior surface of the case.

11. The case according to claim 10, wherein a liner is positioned adjacent each of the first piece of the paper/fabric composite and the second piece of the paper/fabric composite along the interior surface of the case.

12. The case according to claim 9, wherein the viscose fabric is a viscose fleece.

13. The case according to claim 9, wherein the viscose fabric consists of viscose fibers.

14. The case according to claim 13, wherein the viscose fibers are interwoven or amalgamated via hydro-entanglement.

15. The case according to claim 9, wherein the viscose fabric has a specific weight of 40-130 g/m².

16. The case according to claim 9, wherein the Kraft paper has a specific weight of approximately 50-300 g/m².

17. The case according to claim 9, wherein a biopolymer adhesive film is positioned and secured between the Kraft paper and the viscose fabric.

18. The case according to claim 9, wherein biopolymer adhesive film has a specific weight of 5-80 g/m².

19. The case according to claim 9, wherein the Kraft paper of the first piece of the paper/fabric composite and the second piece of the paper/fabric composite are treated with wallpaper glue or starch-based adhesive.

20. The case according to claim 9, further including a strap secured to the first piece of the paper/fabric composite.

21. A case, comprising:
a first piece of a paper/biopolymer composite behaving like a fabric sheet material with all the benefits of paper; and
a second piece of the paper/biopolymer composite;
the first piece of the paper/biopolymer composite and the second piece of the paper/biopolymer composite being sewn together to form a case.

22. The case according to claim 21, wherein a liner is positioned adjacent each of the first piece of the paper/biopolymer composite and the second piece of the paper/biopolymer composite along the interior surface of the case.

23. The case according to claim 21, wherein the paper/biopolymer composite has a specific weight of 127-945 g/m².

24. The case according to claim 21, wherein a paper/fabric composite is joined with the paper/biopolymer composite.

25. The case according to claim 21, wherein an organic material such as felt is used as a liner or core for the case and attached to the paper/biopolymer composite materials.

26. The case according to claim 21, further including a strap secured to the first piece of the paper/biopolymer composite.
